(19) United States
(12) Patent Application Publication
(10) Pub. No.: US 2011/0131421 A1
(43) Pub. Date: Jun. 2, 2011

(54) METHOD FOR INSTALLING AN APPLICATION ON A SIM CARD

(76) Inventors: Fabrice Jogand-Coulomb, San Carlos, CA (US); Mei Yan, Cupertino, CA (US); Javier Cañís Robles, Madrid (ES); Paul McAvoy, Redwood City, CA (US)

(21) Appl. No.: 12/629,593

(22) Filed: Dec. 2, 2009

(51) Int. Cl. G06F 9/445; H04W 12/06; G06F 12/14; G06F 12/00

(52) U.S. Cl. 713/189; 455/411; 717/174; 711/154; 455/558; 711/E12.001

(57) ABSTRACT

A method of installing an application on a SIM card is disclosed. A host agent in a host device installs an application on a Subscriber Identity Module card from a non-volatile storage device. The host agent coordinates mutual authentication between the non-volatile storage device and a Subscriber Identity Module card in the host device. If the mutual authentication is successful, the host agent reads an application from the non-volatile storage device and installs the application on the Subscriber Identity Module card, wherein installing the application enables the Subscriber Identity Module card to execute the application. The application may be protected from tampering or unauthorized copying during the host agent transfer by creation of a secure communication channel or transferring encrypted applications. The Subscriber Identity Module card may verify the signature associated with an application before installation to prevent the installation of unauthorized or tampered applications.

### TECHNICAL FIELD

This application relates generally to the operation of non-volatile flash memory systems, and, more specifically, to a method for installing an application on a Subscriber Identity Module (SIM) card.

### BACKGROUND

The ever-increasing capacity of small form factor memory cards allows for new possibilities in distributing digital content and applications. For example, handheld computing devices such as cellular telephones may provide storage for content and applications, perhaps in a removable non-volatile storage device such as a a SIM (for Global System for Mobile (“GSM”) communication networks) or an R-UIM (for Code Division Multiple Access networks) card, in order to increase the average revenue by generating more data exchanges on a mobile network. Content includes valuable data, which may be data owned by a party other than the one that manufactures or sells the non-volatile storage device. Applications may include calendar or appointment book management, media content players, e-mail or messaging applications, and other applications that may be useful for a subscriber to have on a portable device such as a cellular telephone connected to the network of a Mobile Network Operator (MNO).

The distribution of digital media content or applications to a non-volatile storage device presents a variety of challenges. The owner or the provider of such digital content or applications may wish to limit copying, uploading, or downloading of the digital content or applications to other devices. Further, the application or content provider may prefer to restrict access to the content to one computer, cellular telephone, or other electronic device capable of accessing, displaying, or playing the digital content.

Application or content management schemes may address these and other application or content distribution requirements of digital content providers such as an MNO. Some content management schemes rely on a server from which the applications or content is downloaded. In this approach, the server establishes a connection with the non-volatile storage device via the host device, and applications or digital content are downloaded from the server to the non-volatile storage device.

These and other similar content management schemes require an ability to access the content management server in order to access the content. However, there are many instances where a connection to the server is not possible, such as when an internet, telephone, cellular, or other wired or wireless connection may be unavailable. In these situations, the lack of a server connection may unnecessarily deny a consumer access to an application or content that the consumer should otherwise be entitled to access or purchase. Even if a connection with a server is possible, the communication bandwidth required to transmit content files and applications is an additional consideration. The ever-increasing size of digital content files, such as movies and video clips, and the ever-increasing complexity of applications executable on a cellular telephone device or SIM card, necessarily mean that content or applications will take more time to transfer on a wired or wireless connection with a limited data rate. Further, if many users of a network, such as cellular telephone subscribers of a Mobile Network Operator, attempt to download content or applications simultaneously, the network or server may be unable to efficiently and quickly process all of the transfer requests, causing a negative customer experience.

### SUMMARY

Therefore, it would be advantageous to have a method or system where digital content and application distribution may be achieved with limited use of a content or application server, or without any use of a content or application server. By reducing or eliminating the need for a server to distribute content and applications, a consumer may be able to install applications and access new media even in instances where an internet or other connection to a remote server is unavailable. Further, an alternative application or content distribution method would alleviate the bandwidth requirements on a network used to connect the host device to a content or application distribution server.

In order to address these issues, embodiments of methods and systems for installing an application on a Subscriber Identity Module (SIM) card are disclosed. In one embodiment, a host agent in a host device installs an application on a Subscriber Identity Module card from a non-volatile storage device. The host agent coordinates mutual authentication between the non-volatile storage device and a Subscriber Identity Module card in the host device. If the mutual authentication is successful, the host agent reads an application from the non-volatile storage device and installs the application on the Subscriber Identity Module card, wherein installing the application enables the Subscriber Identity Module card to execute the application. Several implementations are described for protecting the application (such as from tampering or unauthorized copying) as it is transferred between the non-volatile storage device and a Subscriber Identity Module card, ensuring that only approved applications are installed on the Subscriber Identity Module card.

The exemplary embodiments demonstrate methods and systems for installing applications with limited or no use of a content distribution server. Thus, applications may be installed even when a connection to a server is not possible, such as in regions with limited wired or wireless internet access, or when the host device is connected to a network with limited data bandwidth.

Other embodiments and features and advantages thereof are possible and will be, or will become, apparent to one with skill in the art upon examination of the following detailed description and accompanying drawings. Hence, it is intended that the scope of the claimed invention as recited in the claims below will not be limited to the embodiments shown and described herein.

### BRIEF DESCRIPTION OF THE DRAWINGS

The components in the figures are not necessarily to scale, emphasis instead being placed upon illustrating various aspects thereof. Moreover, in the figures, like referenced numerals designate corresponding parts throughout the different views.

FIG. 1 is a diagram illustrating an exemplary system for distributing applications and content using a non-volatile storage device.

FIG. 2 is a diagram illustrating an exemplary system for distributing applications and content using a non-volatile storage device.

FIG. 3 shows exemplary steps for distributing applications and content to a SIM card using the non-volatile storage device of FIG. 2.

FIG. 4 is a diagram illustrating an exemplary transfer and installation of an application from a non-volatile storage device to a Subscriber Identity Module card.

FIG. 5 is a diagram illustrating an exemplary installation of an application to a Subscriber Identity Module card.

FIG. 6 is a diagram illustrating an exemplary installation of an application to a Subscriber Identity Module card.

### DETAILED DESCRIPTION OF THE PRESENTLY PREFERRED EMBODIMENTS

A method for installing an application on a Subscriber Identity Module (SIM) card with limited use of a remote server is explained in further detail in the exemplary embodiments discussed in the foregoing figures and accompanying description.

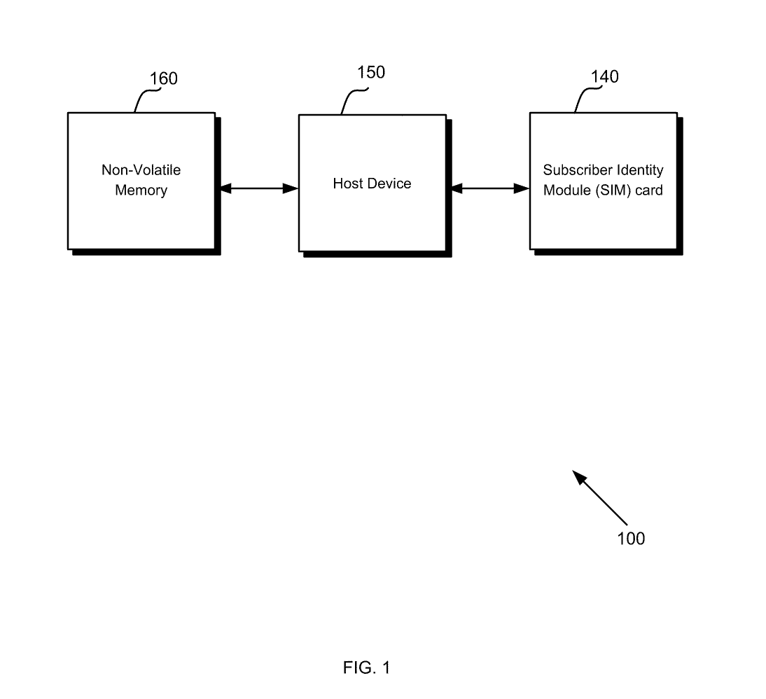

FIG. 1 is a diagram illustrating an exemplary system 100 for controlling host device 150 access to content on a non-volatile storage device 160. In the exemplary system 100, a host device 150 may write, read, erase, modify, or otherwise access content stored in a non-volatile storage device 160. The non-volatile storage device 160 may limit access to the content or storage within the device 160 through a content management or storage access control architecture. In one embodiment, such an architecture may be implemented that minimizes or eliminates the need to contact a remote content management server in order to regulate access to content by a host device 150.

As shown in FIG. 1, a non-volatile storage device 160 may be one of a variety of device types which employ flash EEPROM (Electrically Erasable and Programmable Read Only Memory) cells formed on one or more integrated circuit devices, or other non-volatile storage architectures, to store data or applications. Some of the commercially available card formats include CompactFlash (CF) cards, MultiMedia cards (MMC), Secure Digital (SD) cards, and personnel tags (P-Tag).

A variety of host devices 150 may incorporate or access a non-volatile storage device 160, such as personal computers, notebook computers, personal digital assistants (PDAs), various data communication devices, digital cameras, cellular telephones, portable audio players, automobile sound systems, and similar types of equipment.

A second non-volatile storage device may include a SIM (for Global System for Mobile (“GSM”) communication networks) card 140 or an R-UIM (for Code Division Multiple Access networks) card. The SIM card 140 may be in communication with the host device 150, or installed within the host device 150, such as in a card slot or on a printed circuit board within the host device 150.

The SIM card 140 may be a device capable of executing applications, where applications may include software, firmware, scripts, applets, servlets, or other sets of executable instructions. Such applications may take advantage of the existing capabilities of the SIM card 140, such as access to a Mobile Network Operator (MNO) subscriber's phone book, subscriber identification information within the SIM card such as an International Mobile Subscriber Identity (IMSI) value; another is a Mobile Subscriber Integrated Services Digital Network (MSISDN) value, or access to encryption/decryption algorithms used to protect sensitive information stored on the card. Executing applications on the SIM card 140 instead of the host device 150 may be advantageous because the hardware or operating software within the SIM card 140 is more uniform across a subscriber base of a Mobile Network Operator. Stated another way, the increasing variety of host devices 150 available may make it difficult to write applications operable on each host device 150 platform.

Some applications on the SIM card 140 are installed when the card 140 is manufactured, and thus, before the card 140 is distributed and assigned to a subscriber. However, it may be advantageous to install new applications after the SIM card 140 is distributed to a subscriber. When the host device 150 is a cellular telephone, the host device 150 may contact a network, such as MNO network, in order to receive new applications to install onto the SIM card 140. However, some host devices 150 are incapable of accessing a network, because of the inherent limitations of the host device 150, or because a network cannot be reached by the host device 150, such as when a cellular telephone is operated within a tunnel or in a remote location. Also, the limitations of a network used by the host device 150 may make it impractical to distribute a large application over a network.

In one embodiment, applications may be distributed on a non-volatile storage device 160. A non-volatile storage device 160 may come into communication with a host device, such as over a wired or wireless connection, or when installed within the host device 150, such as in a card slot. A host agent within a host device 150 may read an application from the non-volatile storage device 160, and install the application on the second non-volatile storage device 140, such as a SIM card. In doing so, the dependence on a network connection in order to install an application may be reduced or eliminated.

Such methods and systems for controlling access to protected content with limited use of a remote server are explained in further detail in the additional exemplary embodiments discussed in the foregoing figures and accompanying description.

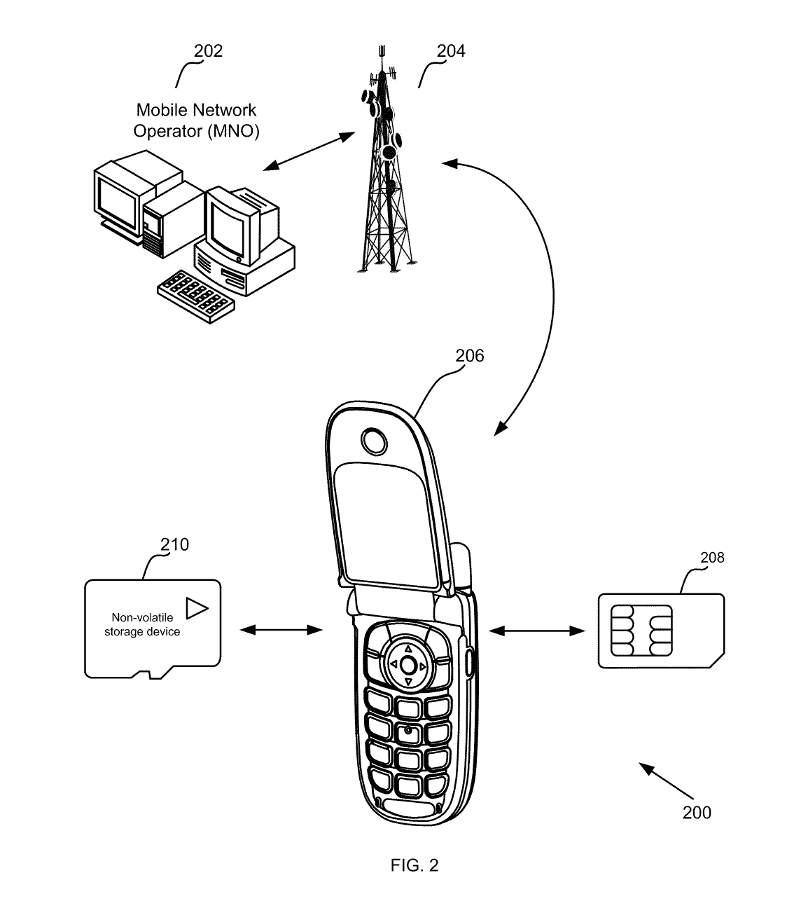

FIG. 2 is a diagram illustrating an exemplary system 200 for controlling access to content on a non-volatile storage device. The system 200 includes a Mobile Network Operator (MNO) 202, a plurality of cellular telephone antennas 204, a cellular telephone 206, a SIM (for Global System for Mobile (“GSM”) communication networks) or an R-UIM (for Code Division Multiple Access networks) card 208, and a non-volatile storage device 210. An MNO 202 may transmit instructions to and receive data from a cellular telephone 206 by transmitting commands, and transmitting and receiving data, through a network of antennas 204 in communication with the cellular telephone 206. Some of the instructions and data transmitted by the MNO 202 include applications to install, and instructions directing the cellular telephone 206 to store the application on the SIM card 208.

A cellular telephone 206 in communication with a mobile network such as Global System for Mobile communication (GSM) or Code Division Multiple Access (CDMA) networks, contains a SIM card or R-UIM card, respectively, that stores one more values that uniquely identify the subscriber or a subscriber's cellular telephone 206. Values that may identify a subscriber include an International Mobile Subscriber Identity (IMSI) value; another is a Mobile Subscriber Integrated Services Digital Network (MSISDN) value. Yet another value is the International Mobile Equipment Identity (IMEI) value, which uniquely identifies GSM-capable cellular telephones.

The card 208, such as a SIM or R-UIM card, may also contain additional secure storage for other variables or parameters defined by the MNO 202. The MNO 202 can read or write to this storage, and configure this storage to allow read-only access to these variables by other entities, such as cellular telephone 206 software applications or hardware. In addition to providing secure non-volatile storage for parameters defined by the MNO 202, the SIM or R-UIM card 208 typically contains a microcontroller that executes applications that may be defined by the MNO 202 and stored within the SIM or R-UIM card 208. Some applications are installed on the SIM or R-UIM card 208 when it is manufactured or before it is distributed to a subscriber. As will be explained further below, other applications will be installed by a host agent running on a host device after the SIM or R-UIM card 208 has been delivered to a subscriber and is in use.

A host device such as a cellular telephone 206 may also store and access content stored in a non-volatile storage device 210, such as a TrustedFlash™ memory device from SanDisk Corporation of Milpitas, California. In one embodiment, some of the content stored on the non-volatile storage device 210 is loaded by the manufacturer or distributor of the device 210. The content may include applications, such as applications including software, firmware, scripts, applets, servlets, or other executable instructions, that may be installed onto the SIM or R-UIM card 208 and executed by the microcontroller or processor on the card.

A host device 206 may include a host agent that may retrieve an application stored in the non-volatile storage device 210, and install it onto the SIM or R-UIM card 208, as will be described in further detail below. The host agent may be an application running on a processor in the host device 206, or may be a component of an operating system running on the host device. In another embodiment, the host agent may be implemented in circuitry in order to implement the functionality described in the figures and accompanying description. As used herein, “circuitry” can include one or more components and be a pure hardware implementation and/or a combined hardware/software (or firmware) implementation. Accordingly, “circuitry” can take the form of one or more of a microprocessor or processor that executes computer-readable program code (e.g., software or firmware stored in a storage medium in the host device 206 (such as, for example, the software routines illustrated in the attached flowcharts)), logic gates, switches, an application specific integrated circuit (ASIC), a programmable logic controller, and an embedded microcontroller, for example.

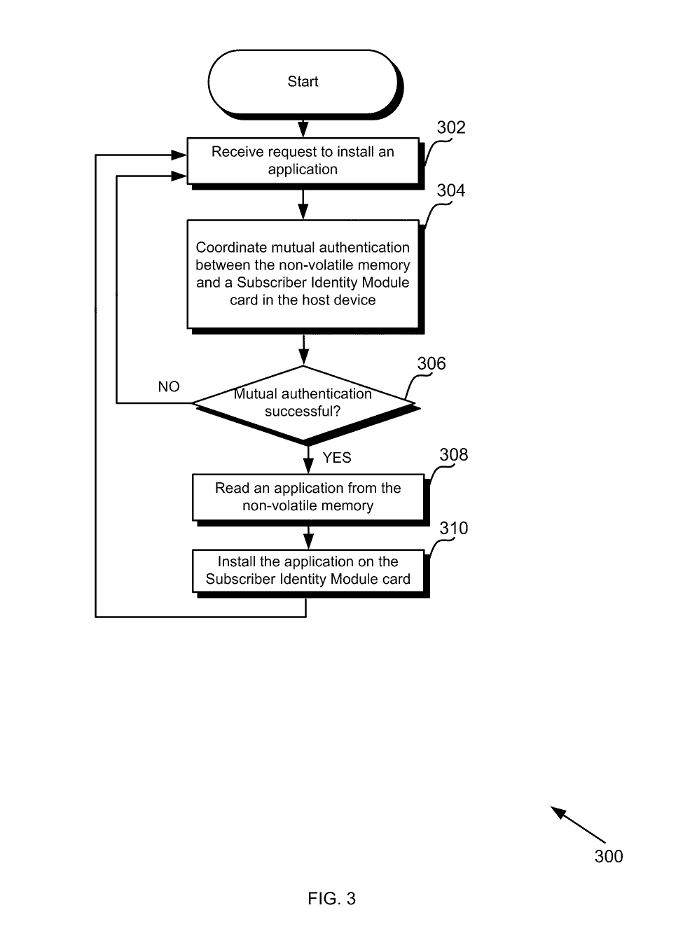

FIG. 3 shows exemplary steps 300 for distributing applications and content to a SIM card 208 using the non-volatile storage device 210 of FIG. 2. Control begins at step 302, where the host agent in the host device 206 receives a request to install an application stored in the non-volatile storage device 210 on the SIM card 208. The request may be in response to an input from the user of the host device 206, such as a user entry on a keypad to select the application to install from the non-volatile storage device 210. In another embodiment, when the host device 206 comes into communication with the non-volatile storage device 210, a list of applications may be automatically retrieved in order to install each application or a set of applications stored on the non-volatile storage device 210, without requiring a user to select the application to install.

Control passes to step 304, where the host coordinates mutual authentication between the non-volatile storage device 210 and a Subscriber Identity Module card 208 in the host device 206. Mutual authentication may include two steps. In one step, the SIM card 208 is authenticated to the non-volatile storage device 210. Stated another way, the SIM card 208 verifies its identity to the non-volatile storage device 210. A non-volatile storage device 210 may limit access to the new applications to certain entities. Thus, the identity of the SIM card 208 may need to be confirmed by the non-volatile storage device 210 before access to the application is allowed. In another step, the non-volatile storage device 210 is authenticated to the SIM card 208. A SIM card 208 may limit the sources of new applications to install to include only applications stored on certain non-volatile storage devices 210. Thus, the identity of the non-volatile storage device 210 may need to be confirmed by the SIM card 208 before the new application is installed.

In one embodiment, the SIM card 208 and non-volatile storage device 210 may not be capable of communicating directly with one another in order to complete the mutual authentication process. In coordinating mutual authentication, the host agent may exchange commands, data, and results between the SIM card 208 and non-volatile storage device 210 in order to facilitate mutual authentication.

Control passes to step 306, where a test determines if the mutual authentication is successful. If mutual authentication is not successful, then the SIM card 208 has rejected the non-volatile storage device 210 as a source of an application to install, or the non-volatile storage device 210 has rejected the SIM card 208 as an approved platform where an application can be installed. In this case, control returns to step 302 to wait for another request. If mutual authentication is successful, control passes from step 308, where the host agent reads the application to be installed from the non-volatile storage device 210. Control then passes to step 310, where the host agent installs the application on the SIM card 208. Control returns to step 302 to wait for another request.

The steps 300 provide a general embodiment for the distribution of an application from the non-volatile storage device 210 to a SIM or R-UIM card 208 for installation. Some aspects of these steps 300 may vary, depending on the embodiment, to address important considerations when distributing content in this fashion. One consideration is to determine if the application should be installed on the SIM card 208. In other words, a MNO 202 may want to restrict the applications that may be installed on the SIM card 208, in order to prevent malicious applications from being installed on the SIM card 208, or so that application providers pay the MNO 202 for the right to install applications on subscriber SIM cards. Similarly, the application provider, such as the entity that sells or distributes the non-volatile storage devices 210 containing the applications, may limit access to applications to those SIM card 208 subscribers or MNOs 202 that have paid for the right to access and install the application.

Another consideration is to ensure that the application is not compromised when it is transferred by the host agent from the non-volatile storage device 210 to the SIM card 208. For example, an application may be compromised when a malicious host agent or another application running on the host device 206 intercepts the application, and makes an unauthorized copy. As another example, an application may be compromised when a malicious host agent or another application running on the host device 206 modifies the application, such as by inserting malicious instructions or a virus into the application, before installation in the SIM card 208.

A variety of embodiments to address aspects of these core considerations are described below. Elements of these embodiments may be used individually, or in combination with one another, to augment, enhance, or modify the steps 300 of retrieving an application stored on a non-volatile storage device 210 and installing it on SIM card 208.

In one embodiment, the non-volatile storage device may authenticate the identity of the SIM card. As previously stated, the host agent performs mutual authentication as one of the steps for retrieving an application stored on a non-volatile storage device 210 and installing it on a SIM card 208. Part of the mutual authentication process is for the non-volatile storage device 210 to authenticate the identity of the SIM card 208. The host agent may coordinate the authentication process with the non-volatile storage device 210 using information supplied by the SIM card 208. For example, in one embodiment, the host agent may supply a password to the non-volatile storage device 210 in order to authenticate the SIM card 208, where the password is supplied by the SIM card 208. The host agent may facilitate a variety of other, more complex authentication operations, such as challenge-response between the non-volatile storage device 210 and the SIM card 208.

In one embodiment, the non-volatile storage device 210 is a TrustedFlash™ memory device from SanDisk Corporation of Milpitas, California. A TrustedFlash™ memory device 210 may implement a secure storage architecture (SSA). Such a secure storage architecture may control access to applications that are physically protected (by controlling access to partitions or a set of addressable memory locations where the application is stored) or logically protected (by controlling access to a key required to decrypt the application before execution). A host agent in a host 206 may authenticate itself to an account in the SSA. Once authenticated, the host 206 may access resources such as decryption keys and storage locations or partitions according to permissions associated with the account. Thus, an SSA system may manage access to applications to install on the SIM card 208.

In one embodiment, logging in to the SSA system through an account, also called an Access Control Record (ACR), is necessary to create, update, or delete data in a non-volatile storage device 210. Further, a host agent in a host device 206 needs to log in to the SSA system through an ACR in order to write data to and read data from the non-volatile storage device 210 using the keys. The privileges of an ACR in the SSA system are called Actions. Every ACR may have Authorizations to perform Actions of the following categories: creating logical partitions, physical partitions, and keys/key IDs, accessing physical partitions and keys, and creating/updating other ACRs. ACRs are organized in groups called ACR Groups or AGPs. Once an ACR has successfully authenticated, the SSA system opens a Session through which any of the Actions of an ACR can be executed. The ACRs and AGPs may be organized in a hierarchical tree of nodes, where each node includes at least one ACR. An ACR may assign its permissions or privileges to child ACRs (ACRs closer to a leaf node on a common branch) within the tree structure, and may receive privileges or permissions from parent ACRs (ACRs closer to the root node on a common branch) within the tree structure,

In order to log into or become authenticated to an ACR, a host agent needs to specify the ACR ID so that the SSA will set up the correct “log in” or authentication algorithms, and select the correct PCR when all “log in” or authentication requirements have been met. The ACR ID is provided to the SSA system when the ACR is created. The SSA system supports several types of “log in” onto the system where authentication algorithms and entity credentials may vary, just as the entity's privileges or authorizations in the system may vary once the entity is logged in or authenticated successfully. In one example, an ACR may require a password “log in” authentication algorithm, where a correct password is the required credential in order to be authenticated. In one example, an ACR may require a PM (public key infrastructure) “log in” authentication algorithm and public key as a credential. Thus, to log in, or be authenticated, an entity will need to present a valid ACR ID and credential, as well as complete the correct authentication or log in algorithm. The authentication algorithm specifies what sort of “log in” procedure will be used by the entity, and what kind of credential is needed to provide proof of the user's identity. The SSA system may support several standard “log in” algorithms, ranging from no procedure (and no credential) and password-based procedures to a two-way authentication protocols based on either symmetric or asymmetric cryptography.

The host agent's credentials correspond to the “log in” algorithm and are used by the SSA to verify and authenticate the entity. An example of a credential can be a password/PIN-number for password authentication, AES-key for AES authentication, etc. The type/format of the credentials (i.e., the PIN, the symmetric key, etc.) is predefined and derived from the authentication mode; they are provided to the SSA system when the ACR is created. In this embodiment, the SSA system has no part in defining, distributing, and managing these credentials, with the exception of PKI-based authentication where the storage device 210 can be used to generate the RSA key pair, and the public key can be exported for certificate generation.

Once authenticated to an ACR, the corresponding Permission Control Record (PCR) specifies the permissions or authorizations within the SSA system. Such permissions may include permission to access a key required to decrypt applications that are stored in an encrypted format in the non-volatile storage device 210, or a permission to read from a storage partition on the non-volatile storage device 210, where the application to be installed may be stored in the partition.

In one embodiment, the SIM card may authenticate the identity of the non-volatile storage device. The host agent performs mutual authentication as one of the steps for retrieving an application stored on the non-volatile storage device 210 and installing it on SIM card 208. Part of the mutual authentication process is for the SIM card 208 to authenticate the identity of the non-volatile storage device 210 that stores the application to be installed. The host agent may coordinate the authentication process with the SIM card 208 using information supplied by the non-volatile storage device 210. For example, in one embodiment, the host agent may supply a password to the SIM card 208, in order to authenticate the SIM card 208, where the password is supplied by the non-volatile storage device 210. The host agent may facilitate a variety of other, more complex authentication operations, such as challenge-response between the non-volatile storage device 210 and the SIM card 208.

In one embodiment, the SIM card 208 implements the GlobalPlatform standard. GlobalPlatform is part of Java Card standard and, as such, part of the SIM card standard. GlobalPlatform defines a protocol to securely load an applet on a smart card. For example, the HTML JavaCard API and Java Card Export File portion of the GlobalPlatform standard defines dynamic post-issuance card management, including dynamic addition and modification of applications, such as installation of applets. Typically, a MNO 202 utilizes the GlobalPlatform standard to interface with the SIM card 208, and establish a secure channel using cryptography techniques in order to transfer data for the card from the MNO 202 to the SIM card 208 over the network 204. In this case, the host agent takes the place of the MNO 202, and utilizes the GlobalPlatform standard to install applications on a SIM card implementing the GlobalPlatform standard.

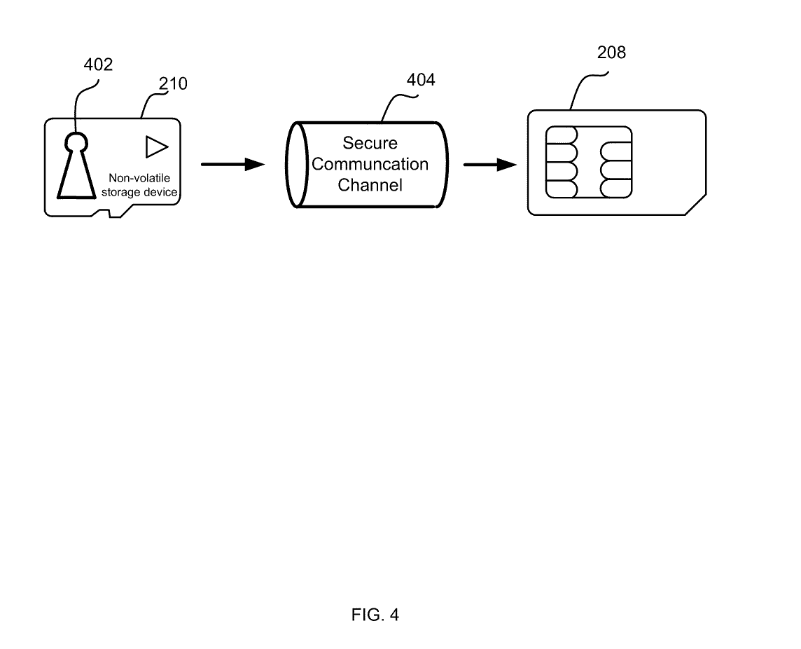

In one embodiment, the host agent may transfer the application from the non-volatile storage device to the SIM card by using a secure transfer method. FIG. 4 is a diagram illustrating an exemplary transfer and installation of an application from a non-volatile storage device to a Subscriber Identity Module card. A non-volatile storage device 210 stores an application 402. In order to avoid tampering of the application 402 during transfer of the application 402 from the non-volatile storage device 210 to the SIM card 208, a secure communication channel 404 is created. In one embodiment, a secure communication channel 404 exists when the non-volatile storage device 210 encrypts data (such as the application 402) before the host agent reads it from the non-volatile storage device 210. The encrypted application is written to the SIM card 208, where the SIM card 208 uses a corresponding decryption key to recover the application 402. In one embodiment, the secure communication channel is bidirectional. Thus, the SIM card 208 may also encrypt data before the host agent reads it from the SIM card 208. The data is transferred to the non-volatile storage device 210, where the non-volatile storage device 210 uses a corresponding decryption key to recover the application 402.

In one embodiment, the SIM card 208 and non-volatile storage device 210 may not be capable of communicating directly with one another in order to establish a secure communication channel 404. In order to coordinate the establishment of a secure communication channel 404, the host agent may exchange commands, data, and results between the SIM card 208 and non-volatile storage device 210 in order to define the encryption and decryption keys used when transferring data, and may perform the read and write operations required to transfer the encrypted data between the devices 208, 210.

Thus, when a secure communication channel 404 is used, the host agent in the host device 206 reads and writes encrypted data, which discourages the unauthorized copying of the application and may prevent it from being tampered with.

In one embodiment, the application 402 may be stored in the non-volatile storage device 210 in an encrypted format and is decrypted by the non-volatile storage device 210, and re-encrypted using an encryption key associated with the secure communication channel 404, before being read from the non-volatile storage device 210 by the host agent. The encryption key associated with the secure communication channel 404 may differ from the key used to encrypt the application when the application was stored in the non-volatile storage device 210.

In a variant of this embodiment, the application 402 may be stored in the non-volatile storage device 210 in an encrypted format, so an additional encryption step is not required before the host agent reads it from the non-volatile storage device 210. Rather, the encrypted application 402 is read from the non-volatile storage device 210 in the encrypted format, and installed on the SIM card 208, where the SIM card utilizes a decryption key to recover the unencypted application.

In one embodiment, the non-volatile storage device 210 and the SIM card 208 are configured with the same keys for encryption and decryption. In this example, the host agent may communicate with the SIM card 208 using the GlobalPlatform protocol in order for the non-volatile storage device 210 to authenticate to the SIM card 208, in order to establish a secure communication channel 404. If the non-volatile storage device 210 is a TrustedFlash™ memory device, an account associated with an application partition or decryption key corresponding to the application may be created in advance 402, such as when the non-volatile storage device 210 is manufactured. The SIM card 208 may store the requisite information to authenticate to the ACR. For example, the ACR account name may be the network ID portion of the IMSI value stored in the SIM card 208. The ACR controls the key used to encrypt and protect the application 402 during the transfer. After both cards 208, 210 have mutually authenticated each other, the host agent drives the reading of the data specifying what key to use using TrustedFlash™ commands and transfers the application as-is to the SIM card 208 using APDU (Application Protocol Data Units) commands in accordance with the GlobalPlatform protocol. The host agent has no access to the decrypted application 402, thus reducing the possibility of tampering while transferring the application over the secure communication channel 404 to the SIM card 208.

In another embodiment, GlobalPlatform on the SIM card 208 is used with diversification, which means that each SIM card 208 is assigned its own decryption key. The process remains the same as before with7 the only difference that the non-volatile storage device 210 must first calculate the SIM card key in order to encrypt the application 402 before it is read by the host agent. As such, the non-volatile storage device 210 shall be provided with a master key and an algorithm used to calculate an encryption key corresponding to decryption key assigned to the SIM card 208. The calculated encryption key may be utilized by the non-volatile storage device 210 to encrypt the application 402 before it is read from the non-volatile storage device 210 by the host agent.

In another embodiment, PKI (public key infrastructure) may be used to “log in” to the ACR of the non-volatile storage device 210, with the public key as the authentication credential, and also may be used to create a secure communication channel 404 for the transfer of the application. In this embodiment, the storage device 210 can be used to generate the RSA key pair and the public key can be exported for certificate generation in order to securely transfer the application. Mutual authentication using PM results in a secure channel for the transfer of the application 402.

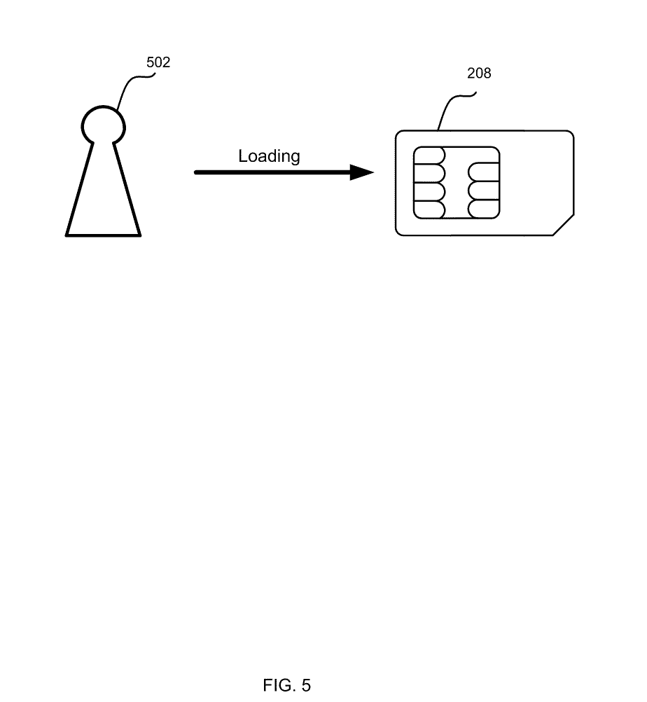

In one embodiment, the SIM card may verify a signature of the application before installing the application. FIG. 5 is a diagram illustrating an exemplary installation of an application to a Subscriber Identity Module card. In this embodiment, a SIM card 208 may be adapted to verify the signature in a signed application 502. The host agent writes or installs the signed application 502 to the SIM card 208 as described in the steps 300 shown in FIG. 3. However, the SIM card 208 verifies the signature of the signed application 502 before installing the application. If the signature is valid and trusted the application is installed. If the signature is not valid the application is not installed and, thus, is not available to be executed by the SIM card 208.

In one embodiment, the application may be signed by more than one signature key in order to create a signed application 502. This allows the signed application 502 to be targeted to multiple MNOs 202. The non-volatile storage device 210 may store a number of signatures corresponding to the signature keys used to sign the application and create a signed application 502. In this embodiment, the host agent may retrieve a signature identification value from the SIM card 208, such as the network ID field from the IMSI value stored in the SIM card 208, in order to select to correct signature from the set of signatures. Each signature may correspond to a participating MNO 202 that may permit the application to be installed on a subscriber SIM card 208. The host agent may utilize the signature identification value to identify the correct signature to use. The host agent may read the identified signature and the application 402 from the non-volatile storage device 210. The identified signature and the application 402 are combined to form a signed application 502, which is then installed on the SIM card 208.

In another embodiment, the host agent may contact a third party such as the MNO 202 in order to obtain a signature key that the non-volatile storage device 210 may use to sign the application at the direction of the host agent, in order to create a signed application 502. The host agent then reads the signed application 502 from the non-volatile storage device 210 and transfers it to the SIM card 208. In this embodiment, the MNO 202 may only provide a signature key if the application is authorized for installation by the MNO 202. This allows distribution of applications without knowing in advance where or if the application 502 will be approved for installation. This embodiment may also allow an MNO 202 to revoke an ability to install applications to a SIM card 208 at any time, by denying the request for a signature key, or providing the host agent with an invalid signature key that will result in a signed application 502 that will be rejected by the SIM card 208.

In one embodiment, a third party such as the MNO 202 authorizes an application to be installed by receiving an application identifier associated with the application to be installed, such as a hash of the application to be installed. The MNO 202 uses the application identifier to determine if the application is authorized for installation. If the application is authorized, the MNO 202 may sign the application identifier and returns it to the host agent. The host agent may receive the signed application identifier, and may combine the signed application identifier with the application read from the non-volatile storage device 210 to form a signed application 502. The host agent transfers the signed application 502 to the SIM card 208. The SIM card 208 then verifies the signed application identifier in order to determine if the application should be installed. In one embodiment, the application identifier transmitted to the MNO 202 is stored in the non-volatile storage device 210. In another embodiment, the application identifier transmitted to the MNO 202 is calculated for the host agent by the non-volatile storage device 210.

To further protect the application from tampering, the application and signature could be transmitted over a secure channel as previously discussed.

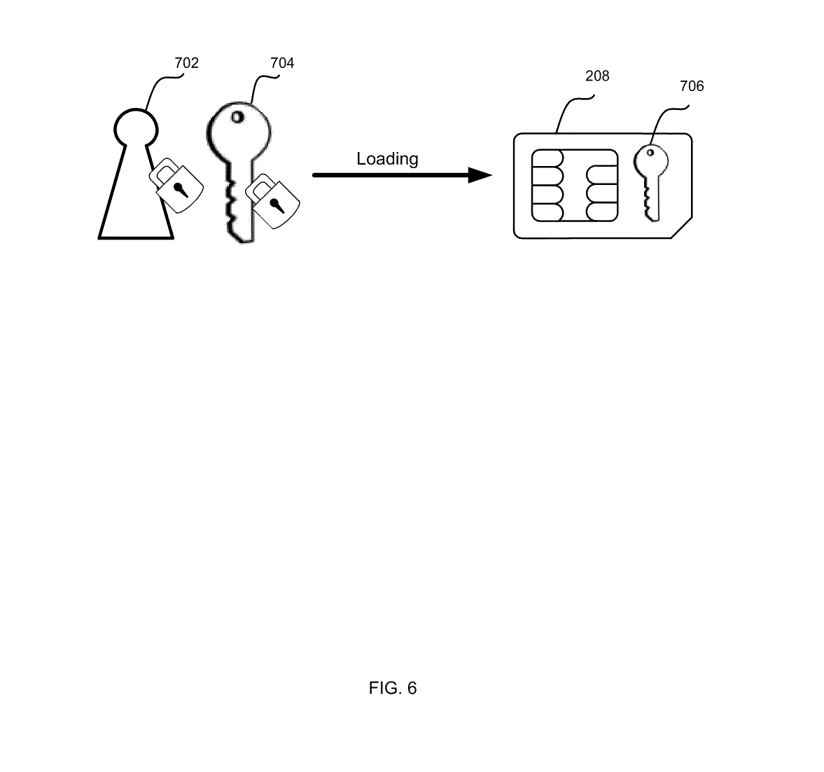

In one embodiment, an application may be protected from tampering during transfer from the non-volatile storage device to the SIM card. FIG. 6 is a diagram illustrating an exemplary installation of an application to a Subscriber Identity Module card. In this embodiment, a SIM card 208 may be adapted to decrypt an encrypted application key 704 transmitted with an encrypted application 702, and then use the decrypted application key to decrypt the encrypted application 702, to recover the application to install. The host agent writes or loads the signed application to the SIM card 208 as described in the steps 300.

However, in this implementation, the application 402 is encrypted with an application to create an encrypted application 702. The application key used to generate the encrypted application is also encrypted with a key corresponding to a decryption key 706 accessible to the SIM card 208, to create an encrypted application key 704. The encrypted application 702 and the encrypted application key 704 are transferred to the SIM card 208. The SIM card decrypts the encrypted application key 704 using the decyption key 706, in order to recover the application key. The application key is then used to decrypt the encrypted application 702, in order to recover the application 402 to install.

In the one embodiment, the non-volatile storage device 210 is a secure device such as a TrustedFlash™ device. In this case, the non-volatile storage device 210 may be utilized to create the encrypted application 702 and the encrypted application key 704. In another embodiment, the non-volatile storage device 210 is not a secure device. Thus, the application key and the application may be compromised if either is stored on the non-volatile storage device in an unencrypted format. In this case, the encrypted application 702 and the encrypted application key 704 are stored on the device 210. A host agent transfers both the encrypted application 702 and the encrypted application key 704 to the SIM card 208. The SIM card 208 then uses its private key to recover the application, using the previously described steps.

In one embodiment, the key used to encrypt the application key is the public key of the SIM card 208. Such an approach is similar to the encryption scheme used to securely transfer data over the internet using S/MIME (Secure/Multipurpose Internet Mail Extensions). In another embodiment, a secure non-volatile storage device 210 may contact the MNO 202 in order to determine the public key used to encrypt the application key to create the encrypted application key 704. The MNO 202 may conditionally distribute the public key to the non-volatile storage device 210, which allows the MNO 202 to control whether an application can be installed on a SIM card in real time (granting or denying each installation request as it is received, by providing or denying access to the public key needed to generate the encrypted application key 704).

Thus, using the algorithms disclosed in the exemplary embodiments, applications distributed on a non-volatile storage device may be installed on SIM or R-UIM cards with limited or no use of a centralized content management scheme such as a MNO, thus allowing applications to be installed when there is limited or no connectivity to a central server. Control over what applications are installed on the SIM card may be achieved through mutual authentication, and optionally, by contacting a central to access a limited amount of information to grant installation rights to a certain application. The integrity of the installed applications may be maintained by digitally signing applications or using secure channels to prevent tampering of the application as it is transferred by the host agent. The distribution of applications may be controlled from the perspective of the non-volatile storage device by requiring authentication to verify the identity of SIM cards authorized to receive the application for installation.

While the description and accompanying figures reference a cellular telephone as the host, a variety of hosts are possible, including, but not limited to, personal computers, personal digital assistants, media players, and other devices capable of communicating with non-volatile storage devices. Further, the non-volatile storage device may be a TrustedFlash™ memory device and or any other secure media device containing preloaded files with secure content.

Although the invention has been described with respect to various system and method embodiments, it will be understood that the invention is entitled to protection within the full scope of the appended claims and the claims are not limited to the exemplary embodiments described herein.

What is claimed is:

1. A method for installing an application on a Subscriber Identity Module card from a non-volatile storage device, the method comprising:
in a host device that includes a host agent and is operatively connected with a non-volatile storage device and a Subscriber Identity Module card, utilizing the host agent to perform:
coordinating mutual authentication between the non-volatile storage device and the Subscriber Identity Module card; and
if the mutual authentication is successful:
reading an application from the non-volatile storage device; and
installing the application on the Subscriber Identity Module card to enable the Subscriber Identity Module card to execute the application.

2. The method of claim 1, wherein coordinating mutual authentication between the non-volatile storage device and the Subscriber Identity Module card comprises:
utilizing an access control record from a tree in the non-volatile storage device, wherein the tree comprises nodes organized hierarchically therein, each node comprising at least one access control record, wherein the access control record comprises credentials and permissions for authenticating the Subscriber Identity Module card to a set of addressable locations in the non-volatile storage device storing the application, and
authorizing access by the host agent to the application stored in the set of addressable memory locations.

3. The method of claim 1, further comprising:
coordinating establishment of a secure communication channel between the non-volatile storage device and the Subscriber Identity Module card through the host device, wherein reading the application from the non-volatile storage device comprises reading the application from the non-volatile storage device over the secure communication channel, and wherein installing the application on the Subscriber Identity Module card comprises installing the application on the Subscriber Identity Module card over the secure communication channel.

4. The method of claim 3, wherein the application stored in the non-volatile storage device is in an encrypted format, and wherein reading the application from the non-volatile storage device over the secure communication channel comprises reading a decrypted application from the non-volatile storage device, wherein the decrypted application corresponds to the application.

5. The method of claim 1, wherein the application stored in the non-volatile storage device is in an encrypted format, wherein reading the application from the non-volatile storage device comprises reading an encrypted application, and wherein installing the application to the Subscriber Identity Module card comprises installing the encrypted application.

6. The method of claim 1, wherein installing the application on the Subscriber Identity Module card comprises:
reading a signature identification value from the Subscriber Identity Module card;
reading a signature corresponding to the signature identification value from the non-volatile storage device;
combining the application with the signature to form a signed application; and
installing the signed application on the Subscriber Identity Module card.

7. The method of claim 6, wherein the signature is one of a plurality of signatures stored in the non-volatile storage device, and wherein the application is signed by signature keys corresponding to each of the plurality of signatures.

8. The method of claim 1, wherein installing the application on the Subscriber Identity Module card comprises:
transmitting an application identifier associated with the application to a third party;
receiving a signed application identifier from the third party;
combining the application with the signed application identifier to form a signed application; and
installing the signed application on the Subscriber Identity Module card.

9. The method of claim 8, the method further comprising reading the application identifier from the non-volatile storage device before transmitting the application identifier to the third party.

10. The method of claim 8, wherein the application identifier is an application hash.

11. The method of claim 8, wherein the third party is a Mobile Network Operator.

12. The method of claim 1, wherein reading the application from the non-volatile storage device further comprises:
receiving a signature key from a third party;
transmitting the signature key to the non-volatile storage device; and
reading a signed application from the non-volatile storage device, wherein the signed application comprises the application signed with the signature key.

13. The method of claim 12, wherein the third party is a Mobile Network Operator.

14. The method of claim 1, wherein the application comprises an application encrypted with an application key, and wherein the method further comprises:
reading the application key from the non-volatile storage device, wherein the application key is encrypted with a Subscriber Identity Module card key; and
transferring the application key to the Subscriber Identity Module card, wherein transferring the application key to the Subscriber Identity Module card permits the Subscriber Identity Module card to decrypt the application key to yield a decrypted application key and to decrypt the application using the decrypted application key.

15. The method of claim 3, wherein the application comprises an application encrypted with an application key, and wherein the method further comprises:
reading the application key from the non-volatile storage device over the secure communication channel; and
transferring the application key to the Subscriber Identity Module card over the secure communication channel, wherein transferring the application key to the Subscriber Identity Module card permits the Subscriber Identity Module card to decrypt the application using the application key.

16. The method of claim 1, wherein the application comprises an application encrypted with an application key, and wherein transferring the application stored in the non-volatile storage device to the Subscriber Identity Module card comprises:
reading the application from the non-volatile storage device;
reading an application key from the non-volatile storage device;
receiving a Subscriber Identity Module card key from a third party;
encrypting the application key with the Subscriber Identity Module card key to form an encrypted application key; and
transferring the application and the encrypted application key to the Subscriber Identity Module card.

17. The method of claim 16, wherein the third party is a Mobile Network Operator.

18. The method of claim 1, wherein the non-volatile storage device comprises a non-volatile memory card.
